(19) United States
(12) Patent Application Publication
(10) Pub. No.: US 2022/0382393 A1
(43) Pub. Date: Dec. 1, 2022

(54) INPUT DEVICES

(71) Applicant: Hewlett-Packard Development Company, L.P., Spring, TX (US)

(72) Inventors: Chia-Wei Ting, Taipei City (TW); Jung Chun Chen, Taipei City (TW)

(73) Assignee: Hewlett-Packard Development Company, L.P., Spring, TX (US)

(21) Appl. No.: 17/775,925

(22) PCT Filed: Nov. 19, 2019
(86) PCT No.: PCT/US2019/062129

§ 371 Date: May 11, 2022

(51) Int. Cl. G06F 3/0354; G06F 3/038

(52) U.S. Cl. CPC G06F 3/03547; G06F 3/0383

(57) ABSTRACT

Examples described herein relate to an input device consistent with the disclosure. For instance, the input device may comprise a planar surface including a first end and a second end, a hinge positioned between the first end and the second end, a first switch to contact either of the first end or the second end, and a liner positioned between the first end and the second end, wherein the liner is in contact with the hinge.

### BACKGROUND

An input device may be coupled to a computing device to control aspects of the computing device (e.g., computers, tablets, etc.). An input device may include keyboards, pointers, a pointing device, touchpads, and/or other controls for accepting user interaction. For instance, an input device may control a position of a cursor on a display of a computing device and/or otherwise facilitate interaction with the display of a computing device.

### BRIEF DESCRIPTION OF THE DRAWINGS

FIG. 1 illustrates an example of an input device consistent with the disclosure.

FIG. 2 illustrates an example of a system including an input device consistent with the disclosure.

FIG. 3 illustrates an example of a computing device including an input device consistent with the disclosure.

FIG. 4 illustrates an example of an apparatus suitable with a system consistent with the disclosure.

FIG. 5 illustrates an example of a side view of an input device consistent with the disclosure.

FIG. 6 illustrates an example diagram of a non-transitory machine readable medium suitable with a system consistent with the disclosure.

### DETAILED DESCRIPTION

Input devices may be coupled to a computing device to permit control of the computing device. As mentioned, an input device may control a position of a cursor on a display screen of a computing device and/or otherwise facilitate interaction with the display of a computing device. For instance, an input device may be moved in a given direction by a user to cause a cursor on a display screen of a computing device to move in the same direction on the display screen. A user may also manipulate an input device with a finger and/or palm to initiate a first-click and a second-click operation (e.g., double click operation) to allow the user to drag objects on the display screen and/or select items on the display screen.

Some input devices include a joystick and/or depressible button to permit an input such as a click operation to be provided at a location outside of a touch surface of the input device. As such, the disclosure is directed to input devices, as described herein. For example, an input device may comprise a planar surface including a first end and a second end, a hinge positioned between the first end and the second end, a first switch to contact either of the first end or the second end, and a liner positioned between the first end and the second end, where the liner is in contact with the hinge. Notably, such input devices may not include a joystick/depressible button outside of a touch surface of the input device and/or may have an increased travel distance, as detailed herein.

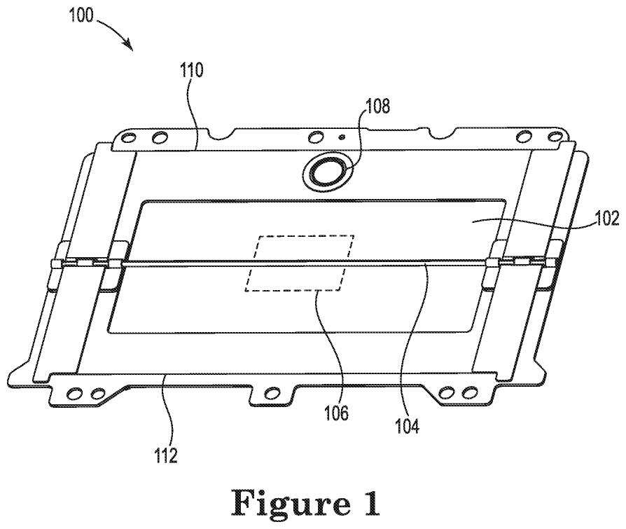

FIG. 1 illustrates an example of an input device 100 consistent with the disclosure. The input device 100 may be implemented to interact with a variety of computing related devices and computing devices, such as desktop computers, portable computers, tablets, etc. In some examples, the input device 100 may be a touchpad. The touchpad may be implemented on a portable computer device to allow for control and positioning of a cursor on a display screen of a computing device. In addition, the touch pad may facilitate interaction with the display of the computing device by moving the cursor and making selections on the display though a first-click and a second-click operation.

In some examples, the input device 100 may include a planar surface 102. As used here, “planar surface” refers to a flat 2-dimensional surface with a zero or near zero curvature. For instance, the planar surface 102 may be a flat sheet of material used to cover the input device 100. However, this disclosure is not so limited. Rather, the planar surface 102 may be substantially flat in shape. For instance, the ends of the planar surface 102 may have slight curve (e.g., a curvature near zero). As used herein, “substantially” refers to a characteristic that does not have to be absolute but is close enough so as to achieve the characteristic. For example, “substantially perpendicular” is not limited to absolutely perpendicular or “substantially parallel” is not limited to absolutely parallel.

The planar surface 102 may be formed of a metal, plastic, fibers, polymer, or combinations thereof, among other possible materials. For instance, in some examples, the planar surface 102 may be formed of a metal such as aluminum, steel, titanium, or combinations thereof, among other types of metals. In some examples, the planar surface 102 may be formed of a polymer such as biaxially-oriented polyethylene terephthalate (BoPET), among other types of polymers.

In some examples, the planar surface 102 may include a first end 110. The first end 110 of the planar surface 102 may be positioned on the uppermost side of the input device 100. Similarly, the planar surface 102 may include a second end 112. In contrast to the first end 110, the second end 112 of the planar surface 102 may be positioned opposite the first end 110 on the lower end of the planar surface 102. That is, the second end 112 of the planar surface 102 may be substantially parallel to the first end 110 of the planar surface 102.

In some examples, a first switch 108 may contact either of the first end 110 or the second end 112 of the planar surface 102. In some examples, the first switch 108 may be adjacent to either of the first end 110 or the second end 112, as illustrated in FIG. 1. However, this disclosure is not so limited. For example, the first switch 108 may be positioned anywhere between the edges of either of the first end 110 or the second end 112. As used herein, “edge” refers to the location in which an object comes to a final stop and/or the boarder of an object. The first switch 108 may send a signal to enable a cursor to select an item on the display screen of a computing device. That is, the first switch 108 may activate to enable a click operation. For example, the planar surface 102 may contact the first switch 108 to activate the first switch 108 and cause the first switch 108 to send a signal to enable a cursor on a display screen of a computing device to select items and perform a click operation. The first switch 108 may be deactivated when the planar surface 102 is not in contact with the first switch 108.

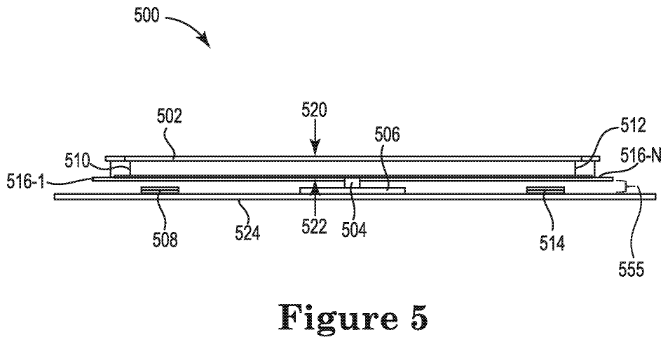

The input device 100 may include a hinge 104. In some examples, the hinge 104 may be substantially parallel to the first end 110 and the second end 112 of the planar surface 102. The hinge 104 may be disposed on the inside of the input device 100. That is, the hinge 104 may be adjacent to the second layer (e.g., second layer 522 of FIG. 5) of the planar surface 102. As used herein, “disposed” refers to a location at which something is physically positioned. In some examples, the hinge 104 may be a cylindrical bar positioned between the first end 110 of the planar surface 102 and the second end 112 of the planar surface 102. In some examples, the hinge 104 may be equal distance between the first end 110 and the second end 112. However, this disclosure is not so limited. For example, the hinge 104 may be closer to the first end 110 of the planar surface 102 or closer to the second end 112 of the planar surface 102.

In some examples, the first end 110 and the second end 112 may transition in opposite directions when activating a first switch 108. For example, the planar surface 102 may balance on a hinge 104 splitting the planar surface 102 into at least two sides. In this example, when a user presses down on the side closer to the first end 110, the side closest to the second end 112 may transition in a direction away from a floor and the side closest to the first end 110 may transition in a direction relative to the floor. If the first switch 108 is adjacent to the first end 110, the first end 110 may contact the first switch 108.

Similarly, when a user presses down on the side closer to the second end 112, the side closest to the first end 110 may transition in a direction away from the floor and the side closest to the second end 112 may transition in a direction relative to the floor. If the first switch 108 is adjacent to the second end 112, the second end 112 may contact the first switch 108. That is, the hinge 104 positioned between a first end 110 and a second end 112 may enable a first-click and a second-click operation on the input device 100. As used herein, “floor” refers to a layer of a system, computing device, or input device that is beneath a liner, hinge, planar surface, and/or switch. For example, the floor may be the layer of the input device in which the liner is disposed on, as illustrated in FIG. 5. However, this disclosure is not so limited. In some examples, the floor may not be included in the input device. For example, the floor may be included in the system and/or computing device. For instance, the input device may be disposed on a layer of a portable computing device or keyboard and the layer may serve as the floor to the input device.

In some examples, including the hinge 104 between the first end 110 and the second end 112 produces a compact double-click (e.g., first-click and second-click operation) input device 100. That is, positioning the hinge 104 between the first end 110 and the second end 112 may produce a smaller more compact input device 100 including a first-click and a second-click operation on the planar surface 102, as compared to input devices without a first-click and a second-click operation on a planar surface and input devices with a first-click and a second-click operation on a planar surface.

Input devices as described herein may have an increased travel distance as compared to other compact input devices. As used herein, “travel distance” refers to the distance in which an end of the planar surface is able to transition, where the distance is measured from the planar surface in a neutral position to the actuated position of a switch. As used herein, “neutral position” refers to the natural position of an object in which all ends, sides, and/or portions of the object are equal distance from the floor. Moreover, a switch may be in an actuated position when it is depressed and activated. In some examples, the input device 100 may include a liner 106 adjacent to the hinge 104 to increase the space between the planar surface 102 and the floor, thereby increasing the travel distance of the input device 100. The hinge 104 may be positioned between the liner 106 and the planar surface 102. However, this disclosure is not so limited. In some examples, the liner 106 may be positioned between the hinge 104 and the planar surface 102.

The liner 106 may be formed of a cloth material, rubber material, plastic material, foam material, or combinations thereof, among other possible materials. In some examples, the liner 106 may be made of soft material that enhances the clicking operation. That is, a user may prefer the click operation of the input device 100 with a liner 106 made of a soft material over the click operation of an input device without a liner 106 made of a soft material.

In some examples, the liner 106 may increase the distance between the planar surface 102 and the floor. The increased distance between the planar surface 102 and the floor may increase the travel distance of the input device 100, as compared to the travel distance of an input device without a liner adjacent to the hinge 104. The liner 106 may have a thickness of from about 0.05 millimeters (mm) to about 3.0 mm. As used herein, “thickness” refers to the distance through an object measured from the top to the bottom, as distinct from a width or a height of an object. The thickness of the liner 106 may cause the planar surface 102 to be positioned farther away from the floor. In some example, positioning the planar surface 102 farther away from the floor may increase the distance the first end 110 and/or the second end 112 may travel to contact the first switch 108.

In some examples, increasing the travel distance of the planar surface 102 may provide an enhanced user experience. That is, a user may prefer the click operation of the input device 100 with a liner 106 producing an increased travel distance over the click operation of an input device without a liner 106. The liner 106 may increase the height of the planar surface 102 thereby increasing the distance the ends (e.g., first end 110 and/or second end 112) of the planar surface 102 may travel to contact the first switch 108.

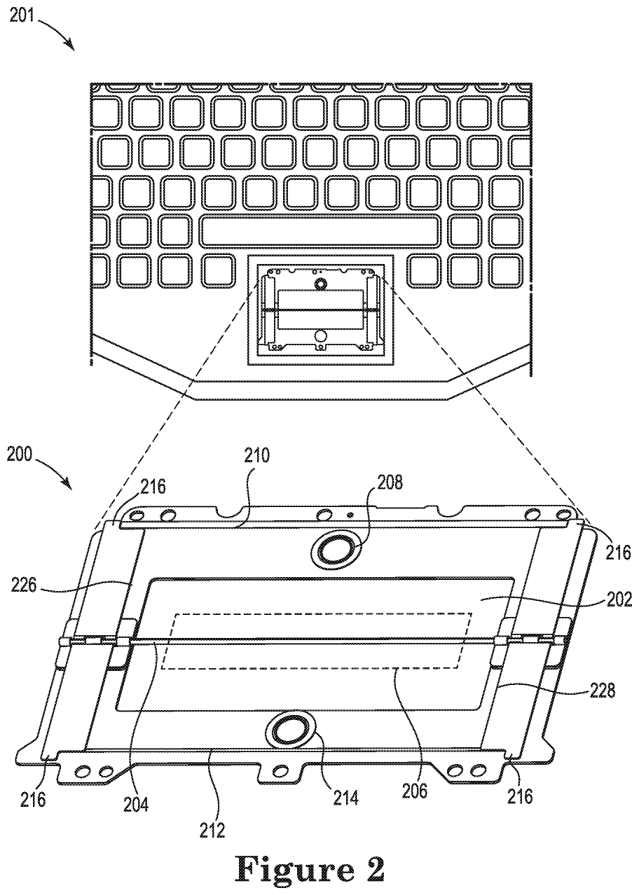

FIG. 2 illustrates an example of a system 201 including an input device 200 consistent with the disclosure. System 201 may be a variety of computer related devices. For example, system 201 may be a keyboard used with a computing device including the input device 100. System 201 may include analogous or similar elements as FIG. 1. For example, system 201 may include an input device 200 comprising a planar surface 202, a first end 210, a second end 212, a first switch 208, a hinge 204, and a liner 206.

The input device 200 of the system 201 may include a planar surface 202. The planar surface 202 may be a flat surface that covers the input device 200. That is, the planar surface 202 may be the top of the input device 200 and no other component of the input device 200 may be above the planar surface 202. The planar surface 202 may include a first end 210 and a second end 212 opposite the first end 210. In addition, the planar surface 202 may include a third end 226 and a fourth end 228. The third end 226 and the fourth end 228 may be substantially perpendicular to the first end 210 and the second end 212.

In some examples, the planar surface 202 may include a first layer in which a user may contact to control a cursor. For example, a user may move their finger and/or palm around the first layer and/or press down on the first layer to cause an action (e.g., move cursor, etc.) on the display screen of a computing device. The planar surface 202 may include a second layer opposite the first layer.

In some examples, the input device 200 may include a first switch 208 to contact a first end 210 and a second switch 214 to contact the second end 212. The first switch 208 may be positioned along the first end 210 of the planar surface 202. Similarly, the second switch 214 may be positioned along the second end 212 of the planar surface 202. In some examples, the first switch 208 and the second switch 214 may be activated by a planar surface 202. The first switch 208 and the second switch 214 may send a signal to a cursor on the display screen of a computing device to select and/or click an item.

In some examples, the input device 200 may include a hinge 204 in contact with the second layer of the planar surface 202. That is, the hinge 204 may be adjacent to the second layer of the planar surface 202. The hinge 202 may be disposed between the first end 210 and the second end 212 of the planar surface 202. In some examples, the hinge 204 may be substantially parallel to the first end 210 and the second end 212. In some examples, the hinge 204 may split the planar surface 202 into two sides (e.g., first and second side). The first side may be above the hinge 204 and substantially parallel to the hinge 204. The second side may be below the hinge 204 and substantially parallel to the hinge 204.

In some example, the first end 210 of the planar surface 202 may transition in a direction relative to the floor to contact and activate a first switch 208. The second end 212 may transition in a direction away from the floor when the first end 210 contacts the first switch 208. For example, the first end 210 may contact the first switch 208 to activate the first switch 208 and cause the first switch 208 to send a signal to cause a cursor on a display screen to perform a function. Similarly, the second end 212 of the planar surface 202 may transition in a direction relative to the floor to contact and activate a second switch 214. The first end 210 may transition in a direction away from the floor when the second end 212 contacts the second switch 214. For example, the second end 212 may contact the second switch 214 to activate the second switch 214 and cause the second switch 214 to send a signal to cause a cursor on a display screen to perform a function.

However, this disclosure is not so limited. For example, the first switch 208 may contact the third end 226 and the second switch 214 may contact the fourth end 228. Further, the hinge 204 may be substantially perpendicular to the first end 210 and the second end 212. That is, the hinge 204 may be substantially parallel to the third end 226 and the second end 228. In some examples, the hinge 204 may split the planar surface 202 into two sides (e.g., first and second side). The first side may be to the left of the hinge 204 and substantially parallel to the hinge 204. The second side may be to the right of the hinge 204 and substantially parallel to the hinge 204. In some examples, the hinge 204 may be equal distance between the third end 226 and the fourth end 228. However, this disclosure is not so limited. For example, the hinge 204 may be closer to the third end 226 of the planar surface 202 or closer to the fourth end 228 of the planar surface 202.

In some example, the third end 226 of the planar surface 202 may transition in a direction relative to the floor to contact and activate a first switch 208. The fourth end 228 may transition in a direction away from the floor when the third end 226 contacts the first switch 208. For example, the third end 226 may contact the first switch 208 to activate the first switch 208 and cause the first switch 208 to send a signal to cause a cursor on a display screen to perform a function. In some examples, the fourth end 228 of the planar surface 202 may transition in a direction relative to the floor to contact and activate a second switch 214. The third end 226 may transition in a direction away from the floor when the fourth end 228 contacts the second switch 214. For example, the fourth end 228 may contact the second switch 214 to activate the second switch 214 and cause the second switch 214 to send a signal to cause a cursor on a display screen to perform a function.

In some examples, the system 201 may include a liner 206 disposed inside an input device 200. In some examples, the liner 206 may be adjacent to the hinge 204. The liner 206 may be disposed on the floor and increase the space between the planar surface 202 and the floor. That is, the liner 206 may increase the travel distance between the planar surface 202 and the floor by increasing the distance between the floor and the planar surface 202.

In some examples, input device 200 may include a plurality of liners 206. For example, the input device 200 may include a plurality of liners 206 adjacent to the hinge 204 to increase the space between the planar surface 202 and the floor. In some examples, each liner 206 of the plurality of liners may be adjacent to the hinge 204 and placed at a different position to increase the space between the planar surface 202 and the floor. In some examples, each liner 206 of the plurality of liners may be placed at a same location. In some examples, liner 206 may be the same length as the hinge 204. However, in some examples, the liner 206 may be shorter than the hinge 206.

In some examples, the input device 200 may include a stopper 216. In some examples, the input device 200 may include a plurality of stoppers 216. For example, the input device 200 may include one stopper 216 at a corner near the third end 226 and the first end 210 of the input device 200 and another stopper 216 at a corner near the fourth end 228 and the second end 212 of the input device 200. In some examples, the input device 200 may include two or more stoppers 216. For instance, the input device 200 may include a stopper on each corner of the input device 200.

In some examples, the stopper 216 may prevent the planar surface 202 from contacting the floor. For example, when a user presses the first side and/or second side of the input device 200 the first end 210 and/or the second end 212 of the planar surface 202 may transition in a direction relative to the and the stopper 216 may prevent the planar surface 202 from contacting the floor. That is, the stopper 216 may contact the floor of the input device 200 and not the planar surface 202. In some examples, preventing the planar surface 202 from contacting the floor may provide an enhanced user experience. That is, a user may prefer the click operation of an input device 200 with a stopper 216 and/or a plurality of stoppers 216.

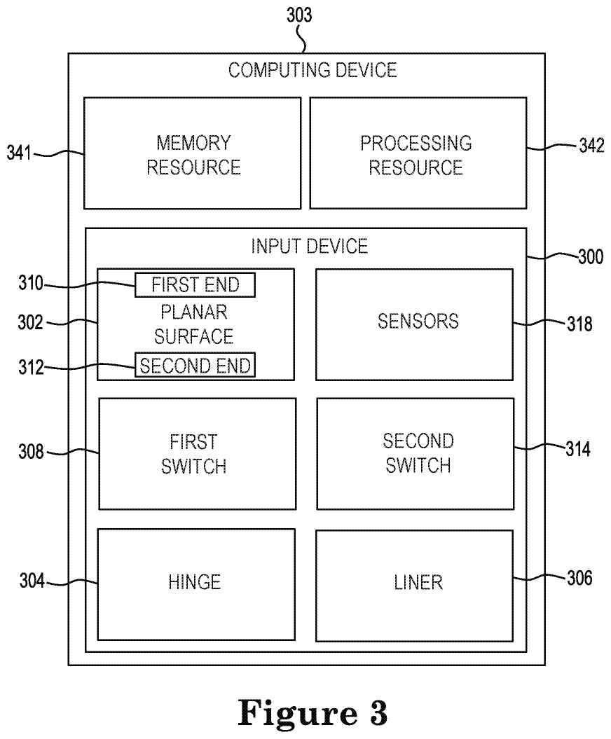

FIG. 3 illustrates an example of a computing device 303 including an input device 300 consistent with the disclosure. Computing device 303 may include analogous or similar elements as FIG. 1 and FIG. 2. For example, computing device 303 may include an input device 300 comprising a planar surface 302, a first end 310, a second end 312, a first switch 308, a second switch 314, a hinge 304, and a liner 306.

In some examples, the computing device 303 may include a memory resource 341 and a processing resource 342 to cause a cursor to move. For example, the computing device 303 may include an input device 300 comprising a planar surface 302 including a first end 310, a second end 312, and a sensor coupled to the planar surface 302 to determine a location of a force and measure an amount of force applied to the planar surface. The sensor may send a signal to the processing resource to cause a cursor on a display screen to move. In some examples, the input device 300 may include a plurality of sensors 318. As used herein, “sensor” refers to a device that has a capability to sense a pressure and converts the sensed pressure into an electric signal where a magnitude of the electrical signal depends upon an amount of the pressure applied.

Examples of sensors 318 include strain gauges and/or piezoelectric films, among other types of sensors. For instance, in some examples the sensors 318 may include strain gauges. For instance, in some examples each of the plurality of sensors 318 may be a respective strain gauge. That is, a user may move a cursor on a display screen by applying a force at a sensor of the plurality of sensors 318 with a finger and/or a palm. Responsive to application of such as force the sensors 318 may determine a location of a force applied and/or an amount of the force applied. For instance, the sensors 318 may send a signal to the processing resource 342 to cause a cursor to move in a direction corresponding to the location of the force responsive to determining the location of the force and/or the amount of the force. That is, the plurality of sensors 318 may be coupled to respective portions of the planar surface 302.

In some examples, the planar surface 302 may contact either of a first switch 308 and a second switch 314. The first switch 308 and/or the second switch 314 may activate and send a signal to the processing resource 342 when contacted by the planar surface 302. For example, as the planar surface 302 contacts the first switch 308 and/or the second switch 314, the planar surface 302 may apply a pressure to the first switch 308 and/or the second switch 314. The applied pressure to the first switch 308 and/or the second switch 314 may activate the first switch 308 and/or the second switch 314. In some examples, the first switch 308 and/or the second switch 314 may send a signal to a processing resource 342 when activated. The processing resource 342 may cause the cursor on the display screen of the computing device 303 to perform a function (e.g., select an item). That is, the planar surface 302 may enable a first-click operation and/or a second-click operation by contacting a first switch 308 and/or a second switch 314.

In some examples, the input device 300 may include a hinge 304 disposed between a first end 310 and a second end 312 of the planar surface 302. The hinge 304 may be substantially parallel to the first end 310 and the second end 312. However, in some examples, the hinge 304 may be substantially perpendicular to the first end 310 and the second end 312. The hinge 304 may split the planar surface 302 into a plurality of sides. For example, the planar surface 302 may be split into two or more sides. For instance, the hinge 304 may divide the planar surface 302 by creating a first side on one side of the hinge 304 and a second side on the other side of the hinge 304.

In some examples, the input device 300 may include a liner 306. The liner 306 may be adjacent to the hinge 304. In some examples, the liner 306 may be disposed on the floor. The hinge 304 may be positioned between the liner 306 and the planar surface 302. In some examples, the liner 306 may increase the amount of vertical space inside of the input device 300. For example, the liner 306 may cause the planar surface 302 to be farther away from the floor.

In some examples, the thickness of the liner 306 may correspond to the distance between the planar surface 302 and the floor. That is, as the thickness of the liner 306 increases the space between the planar surface 302 and the floor may increase. In some examples, the liner 306 may have a thickness ranging from about 0.05 mm to about 3.0 mm. For instance, in some examples, the liner 306 may have a thickness ranging from about 0.05 mm to about 2.9 mm, 0.05 mm to about 2.75 mm, 0.05 mm to about 2.5 mm, 0.05 mm to about 2.25 mm, 0.05 mm to about 2.0 mm, 0.05 mm to about 1.75 mm, 0.05 mm to about 1.5 mm, 0.05 mm to about 1.25 mm, 0.05 mm to about 1.0 mm, 0.05 mm to about 0.75 mm, 0.05 mm to about 0.5 mm, 0.05 mm to about 0.25 mm, 0.05 mm to about 0.2 mm, 0.05 mm to about 0.17 mm, 0.05 mm to about 0.15 mm, 0.05 mm to about 0.12, 0.05 mm to about 0.1 mm, and 0.05 mm to about 0.7 mm.

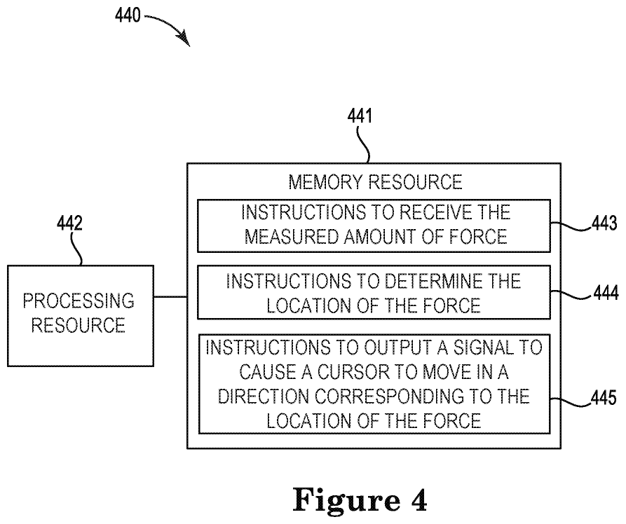

FIG. 4 illustrates an example of an apparatus 440 suitable with a system consistent with the disclosure. As illustrated in FIG. 4, the apparatus 440 includes a processing resource 442 and a memory resource 441. The processing resource 442 may be a hardware processing unit such as a microprocessor, application specific instruction set processor, coprocessor, network processor, or similar hardware circuitry that may cause machine-readable instructions to be executed. In some examples, the processing resource 442 may be a plurality of hardware processing units that may cause machine-readable instructions to be executed. The processing resource 442 may include central processing units (CPUs) among other types of processing units. The processing resource 442 may also include dedicated circuits and/or state machines, such as in an Application Specific Integrated Circuit (ASIC), Field Programmable Gate Array (FPGA) or similar design-specific hardware. The memory resource 441 may be any type of volatile or non-volatile memory or storage, such as random-access memory (RAM), flash memory, read-only memory (ROM), storage volumes, a hard disk, or a combination thereof.

The memory resource 441 may store instructions thereon, such as instructions 443, 444, and 445. When executed by the processing resource 442, the instructions may cause the apparatus 440 to perform specific tasks and/or functions. For example, the memory resource 441 may store instructions 443 to receive the measurement of the amount of force. As mentioned, the sensors may be coupled to the planar surface to measure an amount of force applied to the planar surface. The sensor may measure the amount of force applied to the planar surface by determining the intensity and duration of the force. For instance, as a user contacts the planar surface (e.g., the first layer of the planar surface) with a finger and/or palm the sensor may measure the amount of force the user applies to the planar surface. The sensors may then send a signal to the processing resource 442. The signal may include the measured amount of force. That is, the sensor coupled to the planar surface may send a signal related to the measured amount of force to the processing resource 442.

The memory resource 441 may store instructions 444 which may be executed by the processing resource 442 to determine the location of the force. A user may contact the planar surface at different locations along the first layer of the planar surface. For example, a user may apply a force in one location on the planar surface and slide their finger and/or palm along the planar surface to reach another location of the planar surface. The sensor may determine the location of the force and send a signal including the location of the force to the processing resource 442. That is, the sensor coupled to the planar surface may send a signal related to the location of the force to the processing resource 442.

The memory resource 441 may store instructions 445 which may be executed by the processing resource 442 to output a signal to cause a cursor to move in a direction corresponding to the location of the force. In some examples, the processing resource 442 may receive a signal related to the location of the force to cause a cursor to move in a direction corresponding to the location of the force. In some examples, the processing resource 442 may receive a signal related to the measured amount of force applied to the planar surface to cause a cursor to move. In some examples, the processing resource 442 may receive a plurality of signals. For instance, the processing resource 442 may receive a signal related to the measured amount of force and receive another signal related to the location of the force. In some examples, the sensor may send a signal to the processing resource 442 related to the measured amount of force and the location of the force. The processing resource 442 may receive a signal related to the measured amount of force and the location of the force and output a signal to cause a cursor to move in a direction corresponding to the location of the force responsive to determining the location of the force and measuring the amount of force applied to the planar sensor. That is, the processing resource 442 may receive the signal sent by the sensors and cause a cursor on a display screen to perform a function that corresponds with the received signal.

FIG. 5 illustrates an example of a side view of an input device 505 consistent with the disclosure. Input device 505 may include analogous or similar elements as FIG. 1, FIG. 2, and FIG. 3. For example, input device 505 may comprise a planar surface 502, stoppers 516, a first end 510, a second end 512, a first switch 508, a second switch 514, a hinge 504, and a liner 506.

In some examples, the input device 505 may include a floor 524 and a planar surface 502 including a first end 510 and a second end 512 directly opposite form each other. In addition, the planar surface 502 may include a first layer 520 and a second layer 522. As illustrated in FIG. 5, a hinge 504 may be adjacent to the second layer 522 of the planar surface 502. The hinge 504 may be disposed between the second layer 522 and the liner 506.

The liner 506 may be adjacent to the floor 524 of the input device 500 and the hinge 504. In some examples, the liner 506 may add space between the planar surface 502 and the floor 524 of the input device 500. That is, the liner 506 may increase the distance between the planar surface 202 and the floor 524 of the input device 500 thereby increasing the travel distance 555 of the input device 500.

In some examples, the distance between the planar surface 502 and the floor 524 of the input device 500 may range from about 1.0 mm to about 5.0 mm. For instance, in some examples, the distance between the planar surface 502 in a neutral position and the floor may range from about 1.0 mm to about 1.25 mm, 1.0 mm to about 1.50 mm, 1.0 mm to about 1.75 mm, 1.0 mm to about 2.0 mm, 1.0 mm to about 2.25 mm, 1.0 mm to about 2.5 mm, 1.0 mm to about 2.75 mm, 1.0 mm to about 3.0 mm, 1.0 mm to about 3.25 mm, 1.0 mm to about 3.5 mm, 1.0 mm to about 3.75 mm, 1.0 mm to about 4.0 mm, 1.0 mm to about 4.25 mm, 1.0 mm to about 4.5 mm, 1.0 mm to about 4.75 mm, and 1.0 mm to about 4.9 mm.

In some examples, the input device 500 may include a first switch 508 and a second switch 514 on the floor 524 of the input device 500. As a user presses down on the side of the input device 500 closet to the first end 510, the first end 510 may activate the first switch 508 by contacting the first switch 508. That is, as the first end 510 transitions in a direction relative to the floor 524 of the input device 500, the second end 512 may transition in the opposite direction. Similarly, as a user presses down on the side of the input device 500 closet to the second end 512, the second end 512 may activate the second switch 514 by contacting the second switch 514. As the second end 512 transitions in a direction relative to the floor 524 of the input device 500, the first end 510 may transition in the opposite direction. That is, the input device 500, described herein provides a double click operation utilizing the surface of the input device 500.

In some examples, the input device 500 may include a plurality of stoppers 516 (stoppers 516 collectively refer to stopper 516-1 and 516-N) positioned at the corners of the input device 500. In some examples, the stoppers 516 may prevent the planar surface 502 from contacting the floor 524 of the input device 500. Limiting the contact between the planar surface 502 and the floor 524 may enhance a user experience by providing a pleasurable clicking feel.

In some examples, the stoppers 516 may stop the rise of an end of the planar surface 502. For instance, the stoppers 516 may extend under a computing device, keyboard, and/or computer related device to prevent the end of the planar surface from rising above a certain level. For example, as a user presses down on the side of the input device 500 closet to the second end 512, the second end 512 may transition in a direction relative to the floor 524 and the first end 510 may transition in the opposite direction, as the first end 510 rises (e.g., transition in the opposite direction of the second end 512) the stopper 516-1 may contact and be stopped by the computing device, keyboard, and/or computer related device preventing the first end 510 of the planar surface 502 from rising above a level.

In some examples, the input device 500, as described herein, may provide a compact, double click operation input device with an increased travel distance 555. Some input devices reduce the travel distance of the input device to create a compact input device. However, input devices as described herein have a double click operation, a reduced size, and do not sacrifice the travel distance 555 of the input device creating a compact input device with an enhanced user experience. As such, input devices described herein are able to save cost during production and use less material, which may allow for the production of compact computing devices.

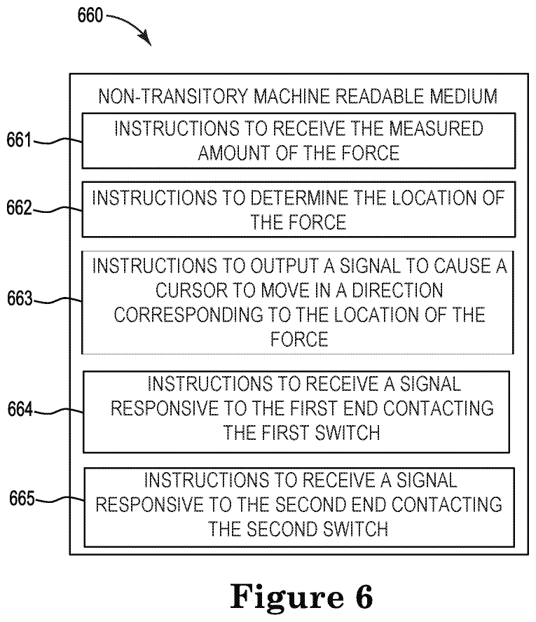

FIG. 6 illustrates an example diagram of a non-transitory machine readable medium 660 suitable with a system consistent with the disclosure. The non-transitory machine-readable medium 660 may be any type of volatile or non-volatile memory or storage, such as random-access memory (RAM), flash memory, read-only memory (ROM), storage volumes, a hard disk, or a combination thereof.

The medium 660 stores instructions 661 executable by a processing resource to receive the measurement of the force. In various examples, the processing resource may execute determine instructions 661 to receive a measured amount of force applied to a planar surface by a user. For instance, the instructions 661 may include instructions to receive a measured amount of force by a sensor such as those described herein.

The medium 660 stores instructions 662 executable by a processing resource to determine the location of the force. In various examples, the processing resource may execute determine instructions 662 to receive the location of a force applied by a user on a planar surface. For instance, the instructions 662 may include instructions to receive a location of a force by a sensor such as those described herein.

The medium 660 stores instructions 663 executable by a processing resource to output a signal to cause a cursor to move in a direction corresponding to the location of the force. In various examples, the processing resources may execute move instructions 663 to output a signal to cause a cursor to move in a direction corresponding to the location of the force. For instance, the move instructions 663 may output a signal to cause a cursor to move in a direction corresponding to the location of the force responsive to receipt of the location of the force and the amount of force applied, among other possibilities.

The medium 660 stores instructions 664 and 665 executable by a processing resource to receive a signal responsive to the first end contacting the first switch and to receive a signal responsive to the second end contacting the second switch. In various examples, the processing resources may execute selection instructions 664 and 665 to output a signal to cause a cursor to select an item on a display screen of a computing device corresponding to the activation of either of the first switch or the second switch. In some examples, as the planar surface contacts the first switch and/or the second switch the switches may be activated and send a signal related to selecting an item to the processing resource. The processing resource may output a signal to cause a cursor to select and/or click an item. For instance, the processing resource may receive a signal relating to a measured amount of force and a location of the force to move a cursor on a display screen to a desired location. In addition, the first switch and/or the second switch may send a signal to the processing resource responsive to the activation of the switch to select and/or click the desired location.

The figures herein follow a numbering convention in which the first digit corresponds to the drawing figure number and the remaining digits identify an element or component in the drawing. Similar elements or components between different figures may be identified by the use of similar digits. For example, 106 may reference element “06” in FIG. 1, and a similar element may be referenced as 606 in FIG. 6.

Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

The above specification and examples provide a description of the method and applications and use of the system and method of the present disclosure. Since many examples can be made without departing from the scope of the system and method, this specification merely sets forth some of the many possible example configurations and implementations.

It should be understood that the descriptions of various examples may not be drawn to scale and thus, the descriptions may have a different size and/or configuration other than as shown therein.

What is claimed:

1. An input device comprising;
a planar surface including a first end and a second end;
a hinge positioned between the first end and the second end;
a first switch to contact either of the first end or the second end; and
a liner positioned between the first end and the second end, wherein the liner is in contact with the hinge.

2. The input device of claim 1, wherein the liner has a thickness of from about 0.05 millimeters (mm) to about 3.0 mm.

3. The input device of claim 1, wherein the hinge is disposed between the liner and the planar surface.

4. The input device of claim 1, further comprising a second switch to contact the second end of the planar surface, wherein the first switch is to contact the first end.

5. The input device of claim 4, wherein the first end and the second end of the planar surface are to transition in a direction relative to a floor.

6. The input device of claim 5, wherein a distance between the planar surface in a neutral position and the floor is about 1.0 millimeters (mm) to about 5.0 mm

7. A system comprising:
an input device comprising:
a planar surface including a first end, a second end, a first layer, and a second layer;
a hinge adjacent to the first layer of the planar surface;
a first switch to contact the first end and a second switch to contact the second end;
a liner disposed on a floor of the input device, wherein the hinge is disposed between the liner and the planar surface; and
a stopper positioned at a corner of the planar surface.

8. The system of claim 7, further including a sensor coupled to the planar surface to determine a location and measure an amount of a force applied to the planar surface.

9. The system of claim 8, further comprising a memory resource and a processing resource to output a signal to cause a cursor to move in a direction corresponding to the location of the force.

10. The system of claim 8, further comprising a memory resource and processing resource to:
receive the measurement of the amount of force; and
determine the location of the force.

11. The system of claim 7, wherein the liner is comprised of a cloth material, rubber material, plastic material, foam material, or combinations thereof.

12. A computing device comprising:
an input device including:
a planar surface including a first end and a second end;
a hinge positioned substantially in a center of the planar surface;
a sensor coupled to the planar surface to determine a location and measure an amount of a force applied to planar surface;
a first switch to contact the first end and a second switch to contact the second end; and
a liner positioned between the first end and the second end, wherein the hinge is positioned between the liner and the planar surface;
a memory resource; and
a processing resource to:
receive the measurement of the amount of force;
determine the location of the force; and
responsive to the determination of the location of the force and the amount of force, output a signal to cause a cursor to move in a direction corresponding to the location of the force.

13. The computing device of claim 12, further comprising a plurality of stoppers positioned at a plurality of corners of the planar surface.

14. The computing device of claim 12, wherein the first switch is substantially in the center of the first end and the second switch is substantially in the center of the second end.

15. The computing device of claim 12, wherein the processing resource is to:
receive a signal responsive to the first end contacting the first switch; and
receive a signal responsive to the second end contacting the second switch.
